(19) United States
(12) Patent Application Publication
(10) Pub. No.: US 2004/0190066 A1
(43) Pub. Date: Sep. 30, 2004

(54) Table driven approach for handling pre-collated media on a printer

(76) Inventors: Robert K. Holzwarth, Pittsford, NY (US); Frederick E. Altrieth III, Scottsville, NY (US)

Correspondence Address: Kevin L. Leffel, Heidelberg Digital L.L.C., 2600 Manitou Road, Rochester, NY, 14624, US

(21) Appl. No.: 10/788,210

(22) Filed: Feb. 26, 2004

Related U.S. Application Data
(60) Provisional application No. 60/459,250, filed on Mar. 31, 2003.

(51) Int. Cl. G06F 15/00; G03G 15/00

(52) U.S. Cl. 358/1.18; 358/1.1

(57) ABSTRACT

A system and method for controlling the usage of pre-collated media within a printing device by creating a template that lists each member of the pre-collated media and iterating through the template using a pointer. The template forms part of a header for a print job that is submitted to the print device. The header indicates where within the documents each member of the pre-collated media is to inserted.

### CROSS-REFERENCE TO RELATED APPLICATIONS

This application claims the benefit of U.S. Provisional Patent Application serial No. 60/459,250 filed Mar. 31, 2003

### BACKGROUND

The present invention relates to pre-collated stock within printing devices and, more particularly, to controlling insertion of pre-collated media at predetermined times.

For several years, the manufacturers of printers and copiers have attempted to arrive at solutions for the proper handling of pre-collated media. Pre-collated stock has a pattern that repeats every so often. The tab stock is a form of pre-collated media. Tab stock is normally pre-cut into ordered banks, with a fixed number of tabs in each bank arranged such that the tabs are offset from one another. The repetitive pattern used in tab stock is generally referred to as a bank. The term “pre-collated” identifies media that has a specific ordering of the sheets with that specific ordering repeating itself.

In the past, some systems have treated pre-collated media as simply a designation for a media drawer containing a specific type of media. For example, they may designate a drawer of media as tab stock without providing any insights into the frequency of repetition or besides the bank of the tab stock. Current printing systems have become so sophisticated that is necessary to actually know the position of the text that is intended to be placed on the various types of pre-collated media. Numerous prior art devices have used counting schemes to determine the frequency of repetition of pre-collated media. However, these prior art systems do not address modern-day needs of determining the correct positions to print text on pre-collated media. The needs of current systems cannot be satisfied by counting through the pieces of pre-collated media.

Until recently, many high-speed print devices did not possess a predetermined mechanism to handle pre-collated stock. Therefore, it was required to eject a certain number of pages off the top of the stack of pre-collated media in order to obtain a known state. Media jams within the printing device created even greater problems, because the operator had to determine the correct piece of pre-collated media within the ordered set that was to be on top of the drawer to restart printing. Printing documents using tabs (or other types of pre-collated media) can be difficult because of the potential for the occurrence of paper jams. For example, a high-end printing device such as the Digimaster™ 9110, manufactured by Heidelberg Digital LLC in Rochester N.Y., is capable of printing in excess of 100 pages per minute. The entire paper path for the Digimaster™ 9110 can be extremely long, depending on the type of finishing device that is employed with the Digimaster™ 9110. Accordingly, the number of pages that are currently inside the Digimaster™ 9110, can be substantial. This increases the likelihood that the paper path might contain pre-collated media after a jam.

Numerous concerns exist within the art of printing systems that use pre-collated media. One of these concerns relates to the handling of pre-collated media in an effective manner. Another concern is recovery from media jams. Recovery is a complicated issue within printing systems that use pre-collated media. Conventional systems are hindered by a lack of knowledge for the pre-collated media that is being used. Specifically, it is not known how many tabs are in a bank or how many sheets are in a pre-printed/pre-collated stock. This limitation forces at least two behaviors that are less than optimal. First, each print job must consume complete sets of the pre-collated media. For tab stock, this requires that unused tabs from a bank of tabs must be included within the application used to create the print job to insure that all tabs within the last bank have been consumed. In this manner, once a current print job completes, the tab stock in the drawer will be ready for the next print job. Secondly, to assist in jam recovery in those cases where pre-collated media has been left in the paper path, the print engine must iterate through the entire job and eject all the pre-collated media for that portion of the job that has not yet printed, as well as those printed prior to the jam. For tabs this means that more than a complete bank might be scrapped. For example, assume a print job uses a five-bank tab stock and the document to be printed includes eight tabs. If a jam occurs, that leaves tab No. 7 in the paper path, the tab stock for tabs No. 8 through tab No. 10 and tabs 1 through tab No. 6 must be ejected. However, it would be sufficient to eject four tabs to resynchronize the tab stock back to the position it was in just prior to when the jam occurred. In this example, nine tabs would have been ejected instead of the four tabs that were actually required because the prior art depend upon counting tabs.

Using tab stock, for example, there may be a three-bank set of tabs used in a document that has four sections in it. The first, second and third tab positions will be used for the first three sections, and the fourth section will use the first tab position. This would leave the second and third tab positions left unused in the second bank of the tab stock. Therefore, the second and third tab positions of the second bank need to be ejected from the printer to insure that a piece of tab stock for the first tab position will be selected for use when printing of the next document begins. It is necessary to always consume a full bank of tabs so the next document will begin printing at the first position. In a similar manner, when using no carbon required (NCR) paper, it is necessary to always consume a full bank of pre-collated media. Using cut tabs, conventional techniques do not typically always consume a full bank.

Co-pending patent application serial No. 60/446,876 based on Invention Disclosure 10476 and entitled “Table Driven Approach For Inserting and Printing Tabs” presents a method and apparatus for creating tab stock templates on a table, rather than from a number of tabs. However, the scope of that Invention Disclosure 10476 is limited to tab creation (e.g., creating tab pages within a PDF document and adding text to them) and does not apply to pre-collated media in general.

Other prior art solutions include information about tabs in a header. However, the pre-collated media is treated as if it was tab stock. It is necessary to designate the pre-collated media in full sets. If a pre-collated media is used as tab stock and had a bank of three, and the document required four tab sections, then two pages from each second set of the tab stock would have to be removed when the print job was sent to the printer. One solution was to tag these two pages of tab stock onto the document. These additional two pages were flagged to be reprinted on the same pre-collated stock as the tabs in the document. These additional two pages were also flagged to be sent out through an alternate exit. High-end printers are complicated devices having numerous exits. For example, the machine will typically have a stapler. These additional pages can run past the stapler to a stacker. There are numerous other exits, such as an exit used for hole punch. In the above example, the bank being used has three tab positions, and there are four sections in the documents being printed. Therefore, a first tab position needs to be used for the fourth section. This leaves the corresponding second and third tab positions to be ejected from the machine in any one of several exits that exist in high-end printing devices. Having to tag these second and third tab positions is a shortcoming within the prior art.

In view of the foregoing discussion, it appears that there is a need within the prior art for a more modern approach to handling pre-collated media in general.

### SUMMARY OF THE INVENTION

The present invention addresses the shortcomings of the prior art by providing a tab stock template extension to a pre-collated media template, and adding the template to the print job header information, thereby allowing the template to be used by the print engine. The availability of this information makes possible greater control of pre-collated media than was achievable using conventional systems within the prior art.

It is an object of the invention to provide a method and apparatus that can accomplish print jobs without using complete sets of pre-collated media.

It is further an object of the invention to provide a method and apparatus that will consume only a minimum of sheets in the event of a media jam within the paper path, while ejecting pre-collated media in an order that will reset the drawer to the state that existed at the point just prior to the media jam occurred.

It is still further an object of the invention to create a method and apparatus wherein pre-collated media could be used in any configuration requested by the user. Such as only using tabs A, C and E of a set of tabs and ejecting tabs B and D.

These and other objects are satisfied by the invention providing for the controlling of pre-collated media within a printing device by forming a list for a set of pre-collated media comprising a plurality of members, detailing, within the list, at least a portion of the plurality of members that are to be used within a document that is being produced by the printer, identifying, within the list, a position within the document for each of the plurality of members that are within the portion that are going to used within the document, and ejecting any of the remaining plurality of members that are not used in the document.

### BRIEF DESCRIPTION OF THE DRAWINGS

FIG. 1 depicts the flow diagram of a production printing system;

FIG. 2 depicts the flow diagram of the functional workflow of a production printing system;

FIG. 3 illustrates a bank of tab stocks commonly used within production printing.

### DESCRIPTION OF THE INVENTION

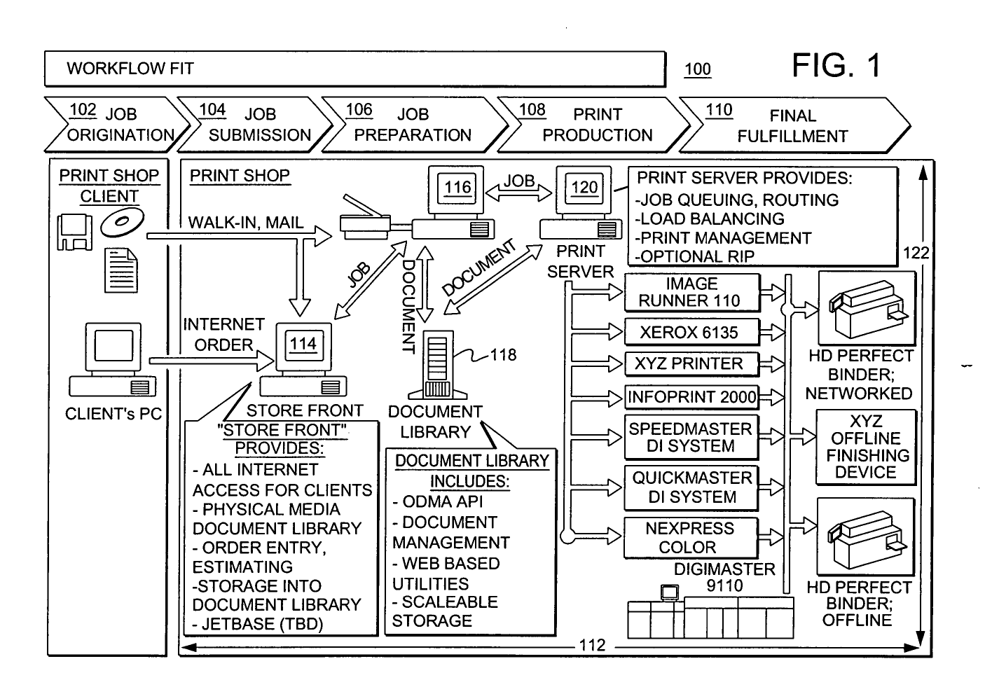

Referring now to FIG. 1, a flow diagram illustrating the production workflow 100 in a production print shop employing a commercial high-volume copying or printing device. A workflow is defined as the tasks, procedural steps, organizations, people involved that are required to input and output information as well as the tools the needed for each step in the business process. A workflow approach to analyzing and managing a business or process, such as production printing can be combined with an object oriented approach, which tends to focus on the discrete objects and processes involved such as documents, pages, data and databases. For the purposes of this disclosure, the term “object oriented”, when applied to the embodiments disclosed herein, does not imply that an object-oriented programming approach is the only method of implementation of the disclosed embodiments.

In a typical digital print shop, there is a network 112 of computer workstations 114, 116, servers 118,120 and high volume output devices 122 which make up the computer network 112. The servers 118,120 include network servers 118 and print servers 120. The topology of the network 112 is typically structured so as to align with the workflow 100 of the print shop. The network 112 may be implemented as a wired or wireless Ethernet network or other form or local area network. Further, the network 112 may include wired or wireless connections to wide area networks such as the Internet and connections to other local area networks such as through a virtual private network.

The production workflow 100 includes the procedural stages of job origination 102, job submission 104, job preparation 106, print production 108 and final fulfillment 110. Alternatively, one or more of these procedural stages may be combined with themselves or with other additional procedural stages. Job origination 102 is the procedural stage of receiving the documents and instructions, which together are defined as a “job”, from the customer. Job origination 102 can occur when a customer physically brings his job, whether in hard copy or electronic form, to the print shop or otherwise transmits the job to the print shop, whether by phone, fax, postal mail, electronic mail or over a local area or wide area network such as over the Internet. It should be noted that a job can contain more than one document and more than one set of instructions. For example, a job could contain many documents, each being one chapter of a book, along with a document containing a cover for the book. This exemplary job may include the instructions for producing the body of the book from the individual chapter documents and another set of instructions for producing the cover. In addition, as will be discussed below, there could be a third set of instructions for assembling the cover to the body of the book.

Job submission 104 is the receipt of the job by the print shop and the entering of the job into the print shops production system or workflow. Typically, the instructions from the customer will be written down on a special form, known as a “ticket” or “job ticket”. A job ticket can also be electronically created and maintained. Furthermore, predefined job tickets may be available that employ standardized instructions. For example, the shop could have a pad of pre-printed job tickets with the instructions to duplicate the documents, three-hole punch the final output and assemble the punched final output in a three ring binder. If this is a common request by customers, such preprinted tickets can save time and resources. The only thing the order-taking clerk would need do in such an instance, is to fill in any customer specific details such as the number of copies to produce. Predefined tickets may help to standardize operations and prevent errors in the transcription of instructions from the customer. In very simple print shops, job submission 104 may simply be the receiving of the original documents and instructions along with the creation of a ticket, placing the job in a paper folder and setting it in a physical queue for later handling in subsequent procedural stages.

In print shops, which handle jobs electronically, job submission 104 requires entering the job into the shop's electronic production system. For documents that are brought in by the customer as hard copy, the documents must first be scanned electronically into the shop's computer system. For documents delivered in electronic form, the document data files must be loaded on the shop's computer system and converted to a document format the production system can handle (such as PDF).

For the job submission stage 104, the computer network 112 may include one or more “store front” workstations 114. The store front workstations 114 are computer systems placed at the order taking desk, at a manned clerk's station or set out for customer self service use. These workstations 114 are used for the job submission stage 104 and typically are configured to handle many different electronic media types such as floppy disk, compact disc, tape, etc. These stations 114 can also be configured to receive jobs over the Internet or other forms of network connections with customers. Furthermore, these workstations 114 are typically configured to read many different electronic file formats such as those used by the Microsoft Office™ family of products manufactured by Microsoft Corporation, located in Redmond, Wash., or various other desktop publishing program file formats such as Adobe Pagemaker™ or Quark Express™. In addition, these workstations 114 can also read “ready for printer” file formats, which will be discussed later, such as Portable Document Format™ (“PDF”) , Postscript™ (“PS”) or printer control language (“PCL”) . Job preparation workstations 114 can also accept image formats such as Tagged Image File Format (“TIFF”) , bitmap (“BMP”) and PCX. These workstations 114 can also include a scanner 117 for scanning hard copies of documents into the computer system. Scanners typically are complicated devices to operate and some print shops may prefer to locate the scanners in the job preparation stage 106 for use solely by trained personnel as will be discussed below. In addition, the store front workstations 114 also provide the ability to generate a job ticket, electronically or in hard copy form, for the print job containing all of the instructions for completing the production printing task. This process of generating the job ticket can be an automated process involving pre-defined tickets, a manual process or a combination thereof, and is discussed in more detail below.

Job preparation 106 involves preparing the documents for printing according to the instructions in the job ticket. For documents that are submitted in hard copy form, job preparation 106 may include scanning the documents and creating a faithful and error free electronic reproduction. The documents, once in electronic form, must also be converted into a common file format that the print shop can use to both edit and print the documents (e.g., distilling to the PDF format). This alleviates the need for operators to deal with multiple, different programs and eliminates the need to assemble complex documents together for printing using different electronic file formats.

For example, a customer might bring in two different documents, one being the body of a book and the other being the photographs to be inserted at specific pages. The customer may then instruct that the photographs be inserted at particular pages and that the final assembly has continuous page numbers added. The body of the book may be in Microsoft Word™ format while the images of the photographs are in Adobe Photoshop® format. While the operator could figure out at which pages the images will be inserted and appropriately number the pages of the book and photographs using each individual software package, this is a very complex and time-consuming process. It also requires that the operator be trained and familiar with a range of software packages and runs the risk that he will not be familiar with the particular package that the customer used. Therefore, it is more efficient to convert each of the various file formats into a unified format that allows the operator to prepare the job using a single software interface. In the preferred embodiments, all documents, whether provided in hard copy or electronically, are distilled or converted into a print ready file format, preferably, the Portable Document Format™ developed by Adobe Systems Inc., located in San Jose, Calif.

A ready for printer file format is defined, herein, as a file format which contains both the data to be printed along with printer control instructions that can be directly interpreted by the internal processing engine of a printer or other form of hard copy output device in order to rasterize the image data onto the output media. Rasterization is the placement of image data at a specific location on the output media. Such file formats include Portable Document Format™ (“PDF”) and Postscript™ (“PS”) which are both manufactured by Adobe Systems Inc., located in San Jose, Calif., as well as printer control language (“PCL”) , manufactured by Hewlett Packard, located in Palo Alto, Calif. Examples of non-ready for printer formats include the native application file formats for personal computer application programs such as Microsoft Word™. These file formats must be first converted to a ready for printer file format before they can be printed. Furthermore, some image file formats, such as the Tagged Image File Format (“TIFF”) contain, or use, “bitmap” image data that is already in a format that specifies image location on the output media. TIFF files do not contain printer control instructions for interpretation by the internal processing engine of the printer and therefore, for the purposes of this disclosure, is not a ready for printer file format. By using a ready for printer format, rasterization of the image data can be delayed as close as possible to the final placement of the image data on the output media. This allows the most efficient use of the production print device 122 by allowing its internal control logic to optimize the rasterization process resulting in output that is more likely to match with the operator's expectations.

For the job preparation stage 106, the computer network 100 includes job preparation workstation 116 coupled with scanners 117 and network servers 118 coupled with the storefront workstations 114 over the network 112. Herein, the phrase “coupled with” is defined to mean directly connected to or indirectly connected through one or more intermediate components. Such intermediate components may include both hardware and software based components. The job preparation stations 116 preferably execute workflow management software, described in more detail below, which allows the operator to manage, edit and print jobs. The network server(s) 118 may include a document library which allows manipulation, management, storage and archiving of jobs, or their respective documents and/or tickets, as well as facilitates and manages the flow of jobs from the store front computers 114 to the job preparation stations 116 and from the job preparation stations 116 to the print servers 120 or the production output devices 122. Exemplary document libraries include DocSmart™ document management system manufactured by MosaicSoft, Inc. located in Laguna Hills, Calif., Intra.Doc™ document management system manufactured by Intranet Solutions, Inc., located in Eden Prairie, Minn. and the DOCFusion™ document management system manufactured by Hummingbird, Inc., located in York, Ontario, Canada. In the preferred embodiment, the job preparation stations 116 are Imagesmart™ Workstations, manufactured by Heidelberg Digital, L.L.C., located in Rochester, N.Y. Alternatively, an appropriate computer hardware platform with the processing capabilities of a Pentium™ class processor, manufactured by Intel Corporation, located in Santa Clara, Calif., has 64 megabytes of RAM or more, a 20 gigabyte hard disk or larger and appropriate display device may be used. Further, in the preferred embodiment, the network servers 118 preferably comply with the Open Document Management Architecture (“ODMA”) standard and provide document management capabilities and scaleable storage.

The job preparation workstations 116 also provide the capability of the print shop to add value to the print production process by offering services to the customer. Such services include the ability to modify documents provided by the customer to add features that the customer could not or would not add himself. Such features include adding page numbers across multiple documents, bates numbering, adjusting page layout for tab stock and aligning the output to account for binding. Further, the job preparation stations 116 provide the capability to fix errors in the documents such as removing artifacts in scanned images and masking over unwanted text or markings. The job preparation stations 116 can also be used to prevent inaccuracies in the finished output caused by the printing or binding process. Such inaccuracies include binder's creep, which happens after a document is imposed into a booklet/pamphlet using a signature imposition. Binder's creep occurs when the placement of the images on the paper fails to account for the thickness of the binding as a function of the number of pages in the book causing the image on the pages to shift inward as you get closer to the cover. Binder's creep can be prevented by shifting the image slightly while performing the signature imposition on the document. In addition, the job preparation station 116 allows the operator to manage and layout the document pages for final output, also known as “imposition” and “signature imposition”. In addition, the operator can shuffle pages, reverse pages, insert blank pages, trim and shift pages, create bleeds and place multiple pages on a sheet, also known as “n-up” to create proof sets, brochures or pamphlets, etc. Furthermore, the job preparation station 116 permits the operator to add annotations to the document such as bates numbers, page numbers, logos and watermarks. All of these services add value to the final output. Formatting and other modifications to the document can be globally applied to the entire document, such as a shifted margin or may be applied only to select pages. Such alterations to the document are known as page features or attributes. Page features, attributes and alterations are also known as page exceptions since they typically override specific instances of the original document formatting as set by the customer.

The next stage in the print production workflow 100 is the print production stage 108. In the print production stage 108, the final form of the documents for printing is sent to a print server 120 which will distribute the job to the final output device 122. In manual print shops, this stage 108 would be similar to an operator manually taking the ready for production job over to the desired output device 122 to start the job. The print production stage 108 manages the output resources of the print shop. Such management includes queuing jobs to the proper devices 122 in the shop, routing jobs to available devices 122, balancing the load placed on the various devices 122, and pre-processing jobs, such as splitting or RIP'ing the job, prior to sending it to a particular device 122. RIP stands for Raster Image Processor and is the hardware and/or software that converts ready for printer data into raster images. It is also a common term for rasterizing a page image onto the output media.

The print server 120 used in the print production stage 108 is coupled with the job preparation stations 116 and the network server 118 over the network 112. Further, the print server 120 is coupled with the various output devices 122 in the print shop. It should be noted that certain output devices 122 might not support electronic transfer of the data to be output and require a manual step for operation. Such devices would typically include a special binding machine that requires that the partially finished documents be manually transferred to the binding machine to complete the production. The print server 120 is preferably implemented as a separate computer coupled with the network 112. However, software based print servers running on a network server 118, job preparation station 116, output device 122 or store front workstation 114 may also be used. In the preferred embodiment, the printer server 120 includes an independent computer workstation, typically running a UNIX or Windows NT operating system, a software print server engine and a software print server application. The print server application offers the user interface ability to configure and manage the print server operation. The print server engine performs the automated processes of the print server. These processes include spooling and queuing jobs and job content (i.e. the document), directing the jobs to specific production output devices based on the attributes of the print job and how these attributes are satisfied by the print engine, load balancing jobs among the various production output devices to keep all printers fully utilized, e.g. to split color from black and white jobs, and acting as a communication gateway where it can accept multiple input communication and print protocols translating them to the communication and print protocol the production output device 122 understands.

The final stage of the production printing workflow 100 is the final fulfillment stage 110. The final fulfillment stage 110 is the stage where the finished output is produced on the production output device 122. A production output device is a computer output device, such as a printer, designed for high volume production of printed documents. Such devices preferably include the ability to produce large quantities of documents with mixed media types and various degrees of finishing, such as stapling or binding, at very high speed. Exemplary printers include the Digimaster™, which is a Digital High Volume Printer manufactured by Heidelberg Digital, L.L.C., located in Rochester, N.Y. and the NexPress™ 2100 Color Printing Press manufactured by NexPress Solutions L.L.C., located in Rochester, N.Y.

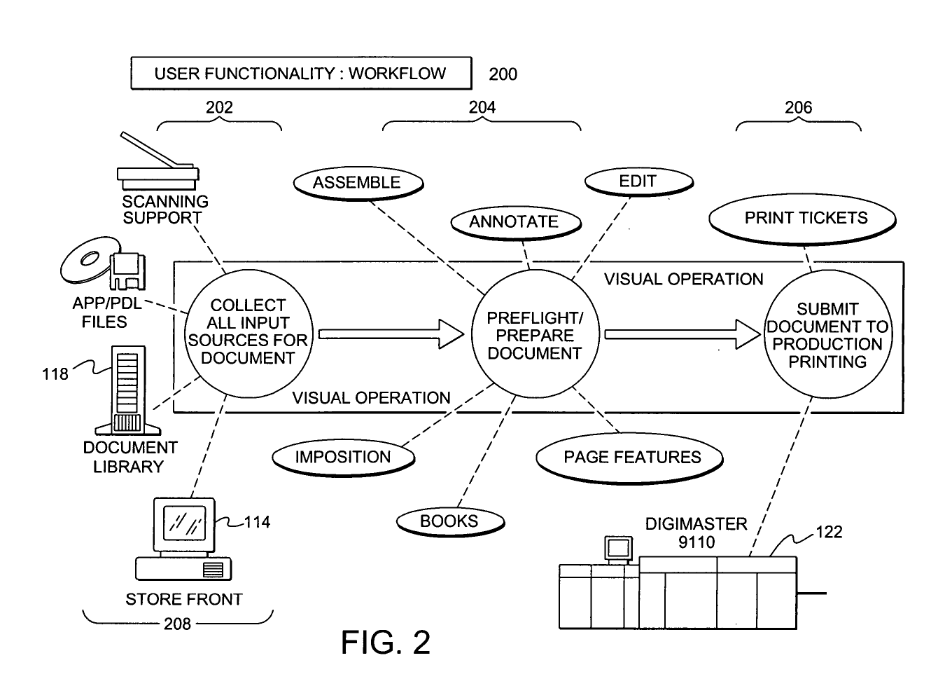

Referring now to FIG. 2, a flow diagram illustrates the user functionality workflow 200 of the preferred embodiment for the job submission and preparation stages 104, 106. The user workflow 200 includes an input source stage 202, a preflight stage 204 and a production stage 206. In the input source stage 202, all of the documents of the job are collected together from the different input sources 208. As previously discussed, the collected documents are preferably converted to a ready for printer format using a Portable Document Format™. This conversion can be a manual or automated process or a combination thereof. For example, a special directory can be created on the network server 118 where data files in various file formats can be placed, for example, by the clerk who accepts the documents from the customer and inputs them into the store front workstation 114. Automated logic, which watches this directory, will see the placement of files and automatically convert them (or flag them for manual conversion) into a ready for printer format. Any documents that the automated logic cannot handle can be flagged for manual conversion. The converted documents are then passed to preflight stage 204 where they are prepared for production. This transfer of converted documents can occur by moving the documents to a special directory on the network server 118 where they can be accessed by the job preparation stations 116 or by transmitting the documents to the job preparation station 116. This process can be manual or automated and may involve placing the documents in a queue of documents waiting to be prepared for production. Further, this process could include a manual or automated determination of the capabilities, skill level or training level of the various operators currently logged into the available job preparation stations 116 as well as the current load/backlog of jobs in their respective queues. Taking these factors into account, the job can be automatically or manually routed to the operator best able to handle the job both technically and in an expedient manner. This functionality can be implemented by creating an operator database which tracks the capabilities, skill level and training level of the various operators who work in the print shop. This database can be coupled with queue management software, which balances the loads/backlogs of jobs at each station 116.

In the preflight stage 204, the documents can be assembled, such as in a book, annotated, edited, imposed, or have page features applied. Once the documents are prepared for production, they are passed to the production stage 206. In the production stage 206, the prepared documents along with the production instructions (from the job tickets) are submitted to the print server or directly to the production output device 122 using a file downloader such as the Print File Downloader™ application program manufactured by Heidelberg Digital, L.L.C., located in Rochester, N.Y. This user functionality workflow 116 may be implemented as a combination of hardware, software and manually executed components and may involve one or more of the components detailed in the production printing workflow above.

In the preferred embodiments, the user functionality workflow is preferably implemented as a workflow management software program and interface that executes job preparation on workstation 116. The preferred workflow management software is visually oriented using an object oriented graphic user interface (“GUI”) approach that integrates control of the workflow functionality in a single interface. While the visual and operational appearance of the management software is object oriented, the implementation of the software can be any object oriented programming language or a non-object oriented programming language known in the art.

In the GUI interface, documents, job tickets and other entities and operations (collectively “objects”) are visually represented on the workstation 116 display, such as with icons, tree structures and pull-down menus, and may be interacted with using known devices and methods such as utilizing a keyboard, a mouse or a track ball to control a visually represented pointing device which is then used to click, select, drag and drop the displayed representations. Such manipulation of the visual representations results in manipulation of the underlying objects (documents, tickets, and other entities and operations). Furthermore, the GUI also permits creation and manipulation of relationships and associations among the various objects and visually displays such relationships and associations. Relationships and associations may be displayed, for example, using a hierarchical approach like a tree structure or file folder structure or using some alternate form of visual indication. It will be appreciated that graphic user interfaces are well known in the art and that numerous software development packages are available, which can be used to develop a GUI. One such package is the Microsoft Foundation Class (MFC) available from Microsoft Corporation, located in Redmond, Wash.

Further, the preferred GUI utilizes a document centric approach, thus providing a centralized viewing window for reviewing documents that are being worked on. In the preferred embodiment, document viewing functionality is provided by the Adobe Acrobat software program, manufactured by Adobe Systems, Inc., located in San Jose, Calif.

As was noted above, the workflow management software integrates applications that implement, control or manage the stages of the production printing workflow 100. These applications include inputting documents from various sources, document assembly including the creation and manipulation of books, document editing, document annotation, document library access on the network server 118, setting and manipulation of page features, creation and manipulation of job tickets and printing.

The workflow management software is capable of receiving input from various different sources. Such sources include hard copy originals input via a scanner, native application formats such as the Microsoft Office™ product suite and desktop publishing applications such as Quark Xpress™, manufactured by Quark. Inc., located in Denver, Colo. and FrameMaker™, manufactured by Adobe Systems, Inc., located in San Jose, Calif. The software can also accept Tagged Image File Format (“TIFF”) documents as well as documents already in a ready for printer format such as PDF, PS or PCL. For hard copy input via a scanner, the software supports industry standard scanner interfaces, TWAIN, as defined by the TWAIN group located in Boulder Creek, Calif. Using these standard interfaces, the workflow management software receives the scanned image data directly in the ready for printer format. An exemplary scanner for use with the preferred workflow software is the Imagedirect™ Scanner manufactured by Heidelberg Digital, L.L.C., located in Rochester, N.Y.

Once documents are loaded into the workflow management software, tools are provided to perform value added services and prepare the documents for production. Assembly is the process of arranging or rearranging pages or adding or removing pages within a document. Assembly also includes imposition where page positions are forced such as when the first page of a chapter is forced to the front side of the paper. The workflow management software provides cut, copy, and paste and move functionality operable on 1 or more pages. This functionality is preferably implemented via pull-down menus, pop up dialog boxes or on screen option palettes or buttons as provide by the graphic user interface. In addition, the results of the respective operations are shown in a visual representation of the document in the centralized document-viewing window on the display for the job preparation station 116.

The workflow management software further provides support for editing and annotating the document. Tools are provided for image object area editing of a scanned page including erase (inside and outside an area), cut, move, copy and paste as well as pencil erase. Page editing tools are also provided for editing on one or more pages including area masking and cropping. Tools are also provided for annotating documents, including alpha numeric and graphic annotations. Exemplary annotations would include page numbering and bates stamping. The tools further provide for placing images behind the document content, also known as watermarking. Annotation can be performed on any portion of one or more pages. Alpha numeric annotations, such as font size and style, are controllable. In all cases, the results of the respective operations are illustrated in the centralized document viewing window on the display for the job preparation station 116. In the preferred embodiments, edits or annotations can be created or manipulated by pointing to a visual representation of the document and/or pages within the document and selecting, dragging, dropping or clicking the representation and/or selecting from a menu of options, where the selection of a particular option causes the associated edit or annotation to be applied to the specified portions of the document. Alternatively, a palette of options may be displayed from which the user may choose an option to apply to selected portions of the document. Further, the interface may provide for a dialog box or other visual control for inputting control values for the edit or annotation such as the starting number of a bates range. The workflow management software preferably provides further support for compound documents that are documents comprised of one or more other documents, such as books comprised of chapters, or course packs comprised of one or more excerpted sources. Compound documents take advantage of the object oriented nature of the workflow management software. A compound document is a collection of one or more documents that have a particular ordering to them such as the chapters of a book. The Compound Document further contains an automatically generated assembled document which is a single document containing the whole assembled Compound Document. Tools are provided which allow simple management of the documents of a Compound Document, assembly and updating of the documents into the assembled document and selective document manipulation, such as selective printing, of the documents within the Compound Document. Tools are also provided which can interpret the content of the documents within the Compound Document and automatically generate a table of tabs in the assembled document. A compound document otherwise acts just like a document and can be edited, annotated, etc. and have tickets associated with it. Further, a compound document can contain other compound documents such as in the case of a multi-volume book. The individual documents and compound documents within the compound document further retain their independent existence and can be edited or printed independently of the Compound Document and shared with other Compound Documents with those edits being either automatically or manually updated into the assembled document within a particular Compound Document. The workflow management software further displays a visual representation, such as with a hierarchical or tree structure, showing the compound document and any associated documents and tickets. In the preferred embodiments, compound documents can be created or manipulated by pointing to the visual representations of one or more documents and/or a visual representation of a Compound Document and selecting, dragging, dropping or clicking and/or selecting from a menu of options, where the selection of a particular option causes the associated feature to be applied to the selected documents or compound documents. Alternatively, a palette of options may be displayed from which the user may choose an option to apply to selected compound documents. Further, the interface may provide for a dialog box or other visual control for inputting control values for the compound documents such as margin values. For example, a user may select one or more documents and then choose a create Compound Document option from a pull down menu. The workflow software then creates a visual representation of the Compound Document on the display showing the association of the compound document to the selected documents. Alternatively, the user may first create a visual representation of a Compound Document and then drag and drop the visual representations of one or more documents onto the Compound Document visual representation. The workflow software then creates the appropriate logical associations of the data for which the visual representations represent.

The workflow management software is also preferably programmed with data about the different production output devices 122 in the print shop or otherwise available and their capabilities or other equipment, such as finishing equipment, which can be utilized either automatically or manually. The software provides tools which allow the operator to set page features/formatting which are made possible by those specific capabilities. Such page features include: the plex of the document such as duplex or simplex (double sided or single sided output); binding options; such as stapling or hole punching; and the availability and control settings for handling tab stock or ordered media. The preferred embodiments preferably support all of the features of the Digimaster™ line of high volume digital printers manufactured by Heidelberg Digital, L.L.C. located in Rochester, N.Y. In the preferred embodiments, these page features can be set by selecting or pointing to a visual representation of one or more pages and selecting from a menu of options, where the selection of a particular option causes the associated feature to be applied to the selected pages. Alternatively, a palette of options may be displayed from which the user may choose an option to apply to selected pages. Furthermore, the interface may provide for a dialog box or other visual control for inputting control values for the feature such as the type of tab stock. Setting page features for specific pages encodes instructions to the production output device 122 for implementing those features within the ready for printer-formatted file. When the production output device 122 receives the file for printing, it will interpret those instructions to implement the desired feature. For page features that the current device 122 cannot handle, the device 122 can signal the operator that manual intervention is required and direct the operator through the appropriate steps to implement the page feature and complete the job. This may include instructing the operator to remove partially finished documents and transfer them to a binding machine for finishing or instructing the operator to load a specific media type or tab stock into the device 122.

Tools are further provided by the workflow management software to support electronic versions of tickets for specifying production output device instructions and parameters, as well as other finishing steps which may or may not be automated, which are global to the document, e.g., job level features or global document attributes. These include such attributes as the general media type or color to use and the method of binding, such as stapling. Tickets, also referred to as print tickets or job tickets, can exist independently of documents or compound documents as was mentioned above. They are independently visually represented on the display by the workflow management software. Tools are provided for manipulating tickets, such as saving, storing and associating them with documents or compound documents in addition to editing their options. In the preferred embodiments, job tickets can be manipulated just like documents, using pointing, clicking, selecting, dragging and dropping. For example, a job ticket can be associated with a document by selecting the job ticket and dragging and dropping it on a particular document. The workflow management software then preferably visually displays the association by showing the ticket under the hierarchy of the document. Once associated, the options set by the ticket will apply to the associated document or compound document. The options represented by the job ticket may be set by selecting the ticket to bring up a dialog box or pull down option menu, which displays the available options and allows modification of the option values. Job tickets associated with documents can be manipulated with the document. For example, saving a document saves all of its associated tickets. Furthermore, the workflow management software provides the capabilities to create libraries of standardized tickets, which can be used, for example, to standardize procedures across multiple franchised print shops.

Finally, the workflow management software provides tools to send the prepared documents and any associated tickets to the production output device for final production. In the preferred embodiments, documents or compound documents can be sent to a production output device by selecting, clicking or dragging the visual representation of the document or compound document to a visual representation of the print server or output device. Alternatively, the user may select an appropriate option from a pull-down menu, pop up dialog box or button palette. The workflow management software supports standard interfaces and protocols to production output devices and print servers. Further, tools are provided for managing, selecting and monitoring multiple production output devices. These tools provide visual feedback of each of the devices' status to the user.

According to the present invention the print shop operator first assembles all input (electronic and hardcopy) into a single electronic document at the job preparation station 116. In an exemplary embodiment the Adobe Acrobat software program is used to identify the location of the tab sheets using a utility that works with the same application used to assemble the input (e.g. an Acrobat plug-in). This information is stored with the document. Using a utility that works with the same application used to assemble the input (e.g. an Acrobat plug-in), the tab label information is entered independent from the tab order. This will normally include the text and font. This information is then stored within the document.

The present invention uses system software to indicate to the print engine the location of printed matter on pre-collated media and the placement of pre-collated media within the document as inserts. Therefore, is not necessary to attempt to count through the pieces of stock within the pre-collated media. The present invention employs a table that informs the print engine of the pre-collated media that is going to be used in printing a document. The preferred embodiment provides the print engine with a pointer to track printing of the pre-collated media. Once the end of the table is reached, the pointer will go back to the first element in the table. Therefore the present invention iterates through the table as opposed to counting ordered stock as in the prior art. The table provides not only control of the pre-collated media but also is capable of providing control over the content that is placed on the pre-collated media. It is possible to create content on the pre-collated media in precise positions simply by sending the information to the printer as part of the print job. In order to insert the pre-collated media into a document at the desired position, the present invention simply instructs the printing device which drawer to pull the pages of pre-collated media at the desired times.

Prior art solutions have addressed tab stock but not pre-collated stock in general. Therefore, a common solution for print shops employing sophisticated printers like those previously described was to simply treat pre-collated media as tab stock. However, the present invention allows tab stock to be treated as pre-collated media. There is a fundamental difference between treating tab stock as pre-collated media compared to the prior art. The behavior can be modified once tab stock is treated as if it was pre-collated. This avoids the limitation that only complete banks of tabs, or other forms of pre-collated stock, are sent down to the printer. The present invention allows iteration through the document by simply iterating through a table. There are clear advantages to iterating through known pieces of pre-collated stock rather than having to iterate through all pages of the document. For example, the present invention does not necessitate ejecting multiple sets of pre-collated media. It is only necessary to eject portions of a set of pre-collated media. This is simply accomplished by ejecting the pre-collated media until the desired piece of pre-collated media is at the top of the drawer. The table approach provides additional information that results in an effective recovery from media jams within the paper path because only a minimal portion of a complete set of pre-collated media has to be ejected. The present invention provides an especially useful technique in the printing of large documents. For example, if a 250-page document is being printed, the printer would only have to cycle through a particular number of the pre-collated media in order to reset the printing device to the same position that it was in when the jam occurred. This is accomplished simply and efficiently by iterating through the table of the pre-collated media until the pointer within the table is in the position just prior to when the jam occurred.

The present invention employs a table driven approach to pre-collated media that differs fundamentally from the approaches taken in the prior art. For example, the prior art device described in U.S. Pat. No. 5,044,619 employs an accounting mechanism for controlling pre-collated stock. In U.S. Pat. No. 5,044,619, the tab stock was physically counted to determine the exact position within a bank of tab stock.

Pre-collated Media Templates

In the past, the ImageSmart™ document mastering tab creation utility defined a print stock template for each different type of tabbed media that was used by a print shop. The information within the template is used to determine the correct location of text on a piece of tab stock media. Using the table-driven approach of the present invention, a job header can be created at print time containing the pre-collated media template and sent to the print engine to be used in a variety of ways. One example of how it could be submitted is as follows:

%KDKPCMTemplate: (MediaName)(PositionName)

Where:

KDKPCMTemplate stands for pre-collated media template, where KDK is a global reference to the syntax used within the preferred embodiment. It will be readily understood by those skilled in the art that numerous variations of syntax can be used.

MediaName represents the name of the media defined in the percent KDKMedia statement; and

PositionName represents the position of the individual sheet within the pre-collated media.

Tab Stock

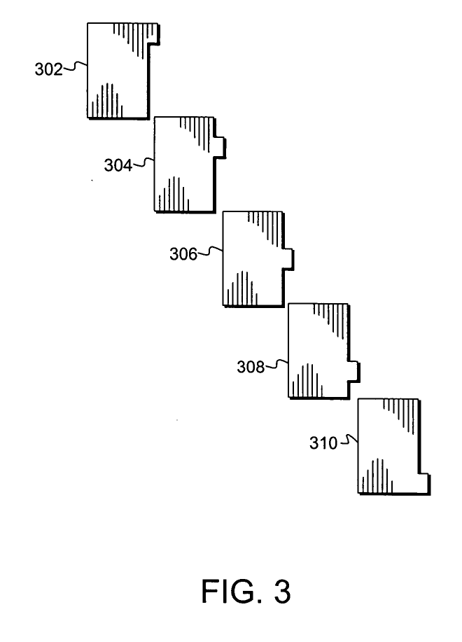

The invention uses system software to indicate to the print engine, the correct placement of information on a specific page, as well as all the pages within a document. Tab Stock is a primary example of the type of pre-collated media for which the invention envisions creating a template. Referring now to FIG. 3, a group of tab stock having a bank of five is shown. This group of tab stock as illustrated in FIG. 3 has the first member of the bank with tabbed media 302 having the tab located at an X position 8.5 inches from the left side of the media as seen in FIG. 3 and a Y position 9.0 inches from the bottom side of the media as seen in FIG. 3. Proceeding in a similar manner, the second member with tabbed media 304 having the tab located at X=8.5 and Y=6.7, the third member of the bank with tabbed media 306 having the tab located at X=8.5 and Y=4.5, the fourth member of the bank with tabbed media 308 having the tab located at X=8.5 and Y=2.3, and the fifth and last member of the bank with tabbed media 310 having the tab located at X=8.5 and Y=0.0.

In a print job header, the specification of the pre-collated media template for tab stock shown in FIG. 3 and as described above would look similar to Table 1 below.

TABLE 1

%% KDKCMTemplate: (LetterTab) (8.5 * 9.0)
%% + (8.5 * 6.7)
%% + (8.5 * 4.5)
%% + (8.5 * 2.3)
%% + (8.5 * 0.0)

In the above print job header, LetterTab is the MediaName and 8.5*9.0 is the first tab position listed in the above Table 1. There are a total of 5 tab positions shown in Table 1. Each of the tabs has an X position of 8.5 while the Y positions are 9.0, 6.7, 4.5, 2.3, and 0.0. These dimensions are in inches, therefore, it should be readily understood that the X position of 8.5 inches is always on the far right side of the media, and the Y positions start towards the top (9.0 inches) and work their way towards the bottom (0.0 inches).

Tab Printing

In the implementations envisioned by the invention, the pre-collated media template information can be added to the header without affecting the syntax of the existing KDK statements. In Table 2 below, an example is given of a document that is being printed having seven tab positions. The pre-collated stock that is being used in the example of Table 2 is tab stock with a bank of four tabs. The print job header within the preferred embodiment would look similar to Table 2.

TABLE 2

%% KDKMedia: (LetterTab) pre-collated
%% KDKPCMTemplate: (LetterTab) (8.5 * 9.0)
%% + (8.5 * 6.7)
%% + (8.5 * 4.5)
%% + (8.5 * 2.3)
%% + (8.5 * 0.0)
%% KDKSlip: (LetterTab) Simplex 5
%% + (LetterTab) Simplex 12
%% + (LetterTab) Simplex 37
%% + (LetterTab) Simplex 52
%% + (LetterTab) Simplex 65
%% + (LetterTab) Simplex 81
%% + (LetterTab) Simplex 93

The KDKMedia directive tells the print engine that “LetterTab” is a pre-collated media. The KDKPCMTemplate definition provides additional detail regarding the pre-collated media. The KDKSlip statement identifies to the print engine exactly which sheets within the print job are to be printed on the pre-collated media. In the example of Table 2, pages 5, 12, 37, 52, 65, 81 and 93 of the document are simplex sheets that are using the tabbed media designated in the KDKPCMTemplate statement.

Still referring to the example in Table 2, it is not necessary for the front-end software to designate which tabs (or other types of pre-collated media) are not going to be used in the job ticket. The print engine can maintain a pointer for the pre-collated media template that points to the name of the next sheet to be pulled. Once a complete copy of the job has printed, the print engine can iterate through the pre-collated media template in accordance with the above table. This iteration process results in a determination that tab positions “8.5*4 5”, “8.5*2.3” and “8.5*0.0” from the second bank of tabs are not used within the document that has just printed and must be ejected to the top exit. If a jam occurred that left tab No. 7 (page 81 within the document) in the paper path, the print engine's pointer within the pre-collated media template would show the last sheet pulled was “8.5*6.7”. The print engine would then only have to eject tabs “8.5*4.5”, “8.5*2.3”, “8.5*0.0” and “8.5* 9.0”. This leaves tab “8.5*6.7” at the top of the paper drawer and the printer would be ready to recover from the jam. In this example, it is only necessary to eject four tabs instead of the 9 tabs that would be ejected in conventional systems.

Tab Printing-extensions

In printing on pre-collated media, it may be desirable to include the position name from the pre-collated media template in the KDK statements which affects the paper pull from a specific paper supply. For example, assume the following syntax exists for specifying page exceptions:

% KDKSlip (MediaName) mode PageNumber

Where:

MediaName=the name of the media defined in the %KDKMedia statement;

Mode=Simplex or duplex printing mode; and

PageNumber=the number of the page to treated as a slip sheet

The foregoing syntax might be extended to the following:

% KDKSlip (MediaName) mode PageNumber (PositionName)

Where:

PositionName=the name of an individual sheet within the pre-collated media template

As an example, a document that is to be printed using the tab stock shown in FIG. 3 to create a document that requires 8 tab positions, the header statement would look like the on shown in Table 3 below.

TABLE 3

% KDKMedia: (LetterTab) pre-collated
%% KDKPCMTemplate: (LetterTab) (8.5 * 9.0)
%% + (8.5 * 6.7)
%% + (8.5 * 4.5)
%% + (8.5 * 2.3)
%% + (8.5 * 0.0)
% KDKSlip: (LetterTab) Simplex 5 (8.5 * 9.0)
%% + (LetterTab) Simplex 12 (8.5 * 6.7)
%% + (LetterTab) Simplex 24 (8.5 * 4.5)
%% + (LetterTab) Simplex 37 (8.5 * 2.3)
%% + (LetterTab) Simplex 52 (8.5 * 0.0)
%% + (LetterTab) Simplex 65 (8.5 * 9.0)
%% + (LetterTab) Simplex 81 (8.5 * 6.7)
%% + (LetterTab) Simplex 93 (8.5 * 4.5)

In the foregoing header shown in Table 3 above, the print engine will know exactly which sheet to use for each drawer pull. If last sheet used was the 8.5*4.5 position, the print engine would simply go to this entry in the pre-collated template for LetterTab and eject a sheet for each subsequent entry. In the simple case shown above, this does not appear to provide a great advantage. However, this added level of detail does open up additional possibilities. For example, assume that the operator only wanted to use three out of the five media tab types from the bank of tab stock shown in FIG. 3; for instance the first, third and fifth tabs from the five-tab bank. Then the header would look similar to Table 4 below.

TABLE 4

%% KDKMedia: (LetterTab) pre-collated
%% KDKPCMTemplate: (LetterTab) (8.5 * 9.0)
%% + (8.5 * 6.7)
%% + (8.5 * 4.5)
%% + (8.5 * 2.3)
%% + (8.5 * 0.0)
%% KDKSlip: (LetterTab) Simplex 5 (8.5 * 9.0)
%% + (LetterTab) Simplex 12 (8.5 * 4.5)
%% + (LetterTab) Simplex 24 (8.5 * 0.0)
%% + (LetterTab) Simplex 37 (8.5 * 9.0)
%% + (LetterTab) Simplex 52 (8.5 * 4.5)
%% + (LetterTab) Simplex 65 (8.5 * 0.0)
%% + (LetterTab) Simplex 81 (8.5 * 9.0)
%% + (LetterTab) Simplex 93 (8.5 * 4.5)

Based on the LetterTab pre-collated media template shown in Table 4 above, the print engine can determine that once the tabbed media 302 at 8.5*9.0 was used, it is necessary to eject tabbed media 304 in the 8.5*6.7 position to get to the tabbed media 306 in the 8.5*4.5 position. In a similar manner, once the tabbed media 306 in the 8.5*4.5 position was used, it is necessary to eject the tabbed media 308 in the 8.5*2.3 position to get to the tabbed media 310 at the 8.5*4.5 position. Since the print engine has a complete definition of the pre-collated media, it can control the usage of the pre-collated media in any desired manner.

Inserts

In print, booklets are often created having a front cover and a back cover that use media types different than the remaining sheets within the document. To accommodate the usage of these front and back covers, inserts are typically used. Table 5 below is an example of a specification for a pre-collated media template that identifies a set of preprinted inserts.

TABLE 5

%% + KDKPCMTemplate: (ColorInsert) (FrontCover)
%% + (NewBuilding)
%% + (BackCover)

Table 5 identifies 3 inserts, the front and back covers as well as another insert for a new building.

Pre-printed Inserts

An example of a situation in which preprinted inserts are used is a document within a print job that has several color pages. These color pages would typically be printed on a color printer and provided in collated sets. These preprinted color sheet sets can then be placed in a drawer of the Digimaster™ 9110. A print job that places color inserts into a document could use information from a pre-collated media template. The header information would look like that shown in Table 6 below.

TABLE 6

%% KDKMedia: (ColorInsert) pre-collated
%% KDKPCMTemplate: (ColorInsert) (FrontCover)
%% + (NewBuilding)
%% + (SellSheet)
%% + (BackCover)
% % KDKCover: (ColorInsert) front Simplex frontside
%% + (ColorInsert) back duplex backside
%% KDKInserts: (ColorInsert) 8
%% + (ColorInsert) 65

In a manner similar to the previously described case using tabs, the KDKMedia directive tells the print engine that the named media (“ColorInsert” in this case) is to be treated as a pre-collated media. The KDKPCMTemplate definition provides additional details regarding the pre-collated media. The KDKCovers and KDKInserts statements tell the print engine which sheets in the job should be printed on the pre-collated media.

The challenges that are presented using preprinted inserts are not as great as the challenges that are encountered using tab stock. First of all, in using preprinted inserts, it is typical for a complete set of inserts to be used within each document for the print job. Therefore, it is only logical that a complete set of preprinted inserts would be requested for each job. However, knowledge about the pre-collated media can still offer improvements to the printing system. The print engine can keep track of the pre-collated media that has been consumed by the printing device on a document-by-document basis. In the event that a media jam occurs in the printing device, it is possible to use the pre-collated media template to determine exactly which pieces of media need to be ejected in order to reset the paper supply. Therefore, the print device would only have to iterate through the relatively small number as determined by tracking the pre-collated media template instead of having to step through the complete print job.

Preprinted Inserts-extension

The previously described concepts can be extended to preprinted inserts. In order to run a print job having color inserts, an extension to the previously described %KDKCovers and %KDKInserts syntax is required. The header information would look similar to Table 7 below.

TABLE 7
%% KDKMedia: (ColorInsert) pre-collated
%% KDKPCMTemplate: (ColorInsert) (FrontCover)
%% + (NewBuilding)
%% + (SellSheet)
%% + (BackCover)
%% KDKCovers: (ColorInsert) front Simplex front side (FrontCover)
%% + (ColorInsert) back duplex backside (BackCover)
%% KDKInserts: (ColorInsert) 8 (NewBuilding)
%% + (ColorInsert) 65 (SellSheet)

Using the header as detailed in Table 7 above, the print engine can keep track of the pre-collated media that has been consumed. In the event of a media jam, the print engine can use the pre-collated media template to determine precisely which sheets need to be ejected to properly reset the paper supply.

NCR Paper

The table driven approach to handling media of the invention has implications on a broader scope than just handling tab stock and pre-printed inserts. An example is No Carbon Required (NCR) paper. The term NCR was originally used for media that served as a replacement of carbon paper and other special documents requiring multiple copies. The most common arrangement of NCR paper is white, yellow and pink pages. Paper vendors market pre-collated NCR paper on the Internet. Out-of-the-box you'll find the NCR paper to be ordered white, yellow, pink/white, yellow, pink etc. NCR media is frequently pre-collated to alleviate the burden of having separate stacks for each color. Without NCR, three separate media drawers would have to be used and the different colors would have to be collated during printing. NCR paper has virtually the same limitations as tab stock. Therefore, in the event of a jam, similar procedures can be employed to resume printing. Initially, it has been known which piece of pre-collated media is required to be removed from the media drawer first. If a jam occurs with a type of pre-collated media stock in the paper path, it is required that the media be cycled through until the correct piece of pre-collated media is in the correct spot for removal from the drawer. In using NCR paper, the biggest concern is a paper jam. If NCR paper having three colors is used, in the event of a jam, the media drawer containing the NCR paper must be manipulated to have the correct color on top. Therefore, using a table driven approach has distinct advantages over prior art methods.

Applications of NCR paper include medical claims forms, routing slips, invoices, packing slips and purchase orders, etc. In high-volume printing, NCR paper is typically simulated by printing multiple copies of the same page image on different sheets of paper. Multicolored “NCR paper” is available as off-the-shelf, pre-collated sets of different colored sheets of paper. A variable print application can be used to create a large job to be printed on NCR paper. A specification of a pre-collated media template as envisioned by the present invention is shown in Table 8 below.

TABLE 8

%% KDKPCMTemplate: (NCR-3) (White)
%% + (Yellow)
%% + (Pink)

The above pre-collated media template in Table 8 provides the print engine with all the information that could be derived from knowing the number of sheets in a set of pre-collated media as well as additional information. Additional advantages to the template approach of the invention will be described in more detail below.

In the following example, the NCR paper is called out as a part of the paper body. The following pre-collated media template and body paper definitions in Table 9 below, are sufficient to allow NCR paper to be used as a pre-collated media within document.

TABLE 9

%% KDKMedia: (NCR-3) pre-collated
%% KDKPCMTemplate: (NCR-3) (White)
%% + (yellow)
%% + (pink)
% KDKBody: (NCR-3) on

The KDKBody statement is a conventional media implementation. However, the above example allows the print engine to realize that NCR-3 is to be treated as a pre-collated media, and the print engine can iterate through the above table to keep track of the media that is in the top position in the paper drawer.

NCR Paper-Extension

The previously discussed extensions can be applied to NCR Paper. As an example, a portion of the header for the print job that uses NCR paper with a document would look like Table 10 below.

TABLE 10

%% KDKMedia: (NCR-3) pre-collated
%% KDKPCMTemplate: (NCR-3) (White)
%% + (Yellow)
%% + (Pink)
%% KDKSlip: (NCR-3) (White)
%% + (Yellow)
%% + (Pink)
%% + (White)
%% + (Yellow)
%% + (Pink)
%% + (White)
%% + (Yellow)
%% + (Pink)

The KDKSlip statement in the Table 10 above can conceivably get quite large and is in fact probably less desirable to use than the basic case that uses just a single KDKBody statement for the entire job. However, this example demonstrates the versatility that can be achieved if desired by including position names within a pre-collated media template.

One of the advantages of this invention that might not be readily apparent is that the implementation is cumulative, based on existing structures. Higher levels of implementation would not preclude the user of the earlier implementation. This results in the potential to phase in the implementation over a period of time and would not, therefore, require all the subsystems within the system to be changed at once.

The foregoing examples are intended to illustrate the environments most preferred by the inventors, numerous variations of these preferred by embodiments will be readily apparent to the skilled in the art. Therefore, the scope of the invention should be measured by the appended claims.

1. A method for controlling pre-collated media within a printing device comprising the steps of:
forming a header for a print job that is readable by the printing device;
creating a template within the header identifying at least one type of pre-collated media that is to be read by the printing device, wherein the pre-collated media has a defined set of unique elements;
placing an entry in the template for each of the unique elements within the pre-collated media; and
iterating through the entries of the unique elements in accordance with the print job.

2. The method of claim 1 wherein the step of iterating further comprises implementing a pointer to iterate through each of the entries within the template.

3. The method of claim 2, wherein the step of iterating further comprises advancing the pointer through all of the entries within the template for each of the defined sets of unique elements within the pre-collated media.

4. The method of claim 1, wherein the step of placing an entry in the template further comprises identifying a location for each of unique elements within the defined sets of pre-collated media where text or graphics are to be printed.

5. A printing system for controlling pre-collated media comprising:
a printing device having an input section capable of inputting a job header for a print job that is readable by the printing device;
a computational element within the printing system that is programmed to read a template within the job header that identifies at least one type of pre-collated media that is to be used in the print job, wherein the pre-collated media is a defined set of unique elements;
a routine associated with the computational element that determines where each of the unique elements is to be placed with the print job; and
an ejection mechanism that removes any of the unique elements that are not used in the print job.

6. The system of claim 5, wherein the routine further comprises a pointer used to read the template to iterate through each of the unique elements within the template.

7. The system of claim 6, wherein the routine further comprises a print type that is to be placed on each of the unique elements.

8. The system of claim 7 wherein the print type can be either text or graphics.

9. The system of claim 6 wherein the routine provides for jam recovery by iterating through the unique elements to place the pre-collated media in a position equivalent to that of the pre-collated media just before jamming occurred.

10. The system of claim 9 wherein the ejection mechanism operates in response to the routine to eject the unique elements of the pre-collated media until the position is reached.

11. A method for controlling pre-collated media within a printing device comprising the steps of:
forming a list for a set of pre-collated media comprising a plurality of members;
detailing, within the list, at least a portion of the plurality of members that are to be used within a document that is being produced by the printer;
identifying, within the list, a position within the document for each of the plurality of members that are within the portion that are going to be used within the document; and
ejecting any of the remaining plurality of members that are not used in the document.

12. The method of claim 11 wherein the step of forming further comprises the list being a linked list.

13. The method of claim 11 wherein the step of ejecting further comprises ejecting the portion of the plurality of members that are not indicated by the identifying step as being used within the document.

14. The method of claim 13 wherein the step of ejecting further comprises placing the set of pre-collated media in a state such that a first member of the plurality of members is next to be used by the printing device.

15. The method of claim 11 wherein the step of ejecting is used in jam recovery to place the set of pre-collated media in an equivalent state as just prior to a paper jam.

16. The method of claim 11 wherein the step of forming further comprises the step of placing a location for material to be printed on each of the plurality of members within the list.

17. The method of claim 16 wherein the step of placing further comprises either text or graphics as the material to be printed.
